(19) United States
(12) Patent Application Publication
(10) Pub. No.: US 2012/0026364 A1
(43) Pub. Date: Feb. 2, 2012

(54) IMAGE PICKUP APPARATUS

(75) Inventor: Toshitaka KUMA, Osaka (JP)

(73) Assignee: SANYO Electric Co., Ltd., Osaka (JP)

(21) Appl. No.: 13/189,218

(22) Filed: Jul. 22, 2011

(30) Foreign Application Priority Data
Jul. 27, 2010 (JP) 2010-168670

(51) Int. Cl. H04N 5/76; H04N 5/228

(52) U.S. Cl. 348/231.99; 348/222.1; 348/E05.031

(57) ABSTRACT

An image pickup apparatus includes a first imaging portion that takes an image of subjects and outputs a signal corresponding to a result of the imaging, a second imaging portion that takes an image of the subjects with a wider angle than the first imaging portion and outputs a signal corresponding to a result of the imaging, and a report information output portion that outputs report information corresponding to a relationship between an imaging area of the first imaging portion and a position of a specific subject based on an output signal of the second imaging portion when the specific subject included in the subjects is outside the imaging area of the first imaging portion.

### CROSS-REFERENCE TO RELATED APPLICATIONS

This nonprovisional application claims priority under 35 U.S.C. §119(a) on Patent Application No. 2010-168670 filed in Japan on Jul. 27, 2010, the entire contents of which are hereby incorporated by reference.

### BACKGROUND OF THE INVENTION

1. Field of the Invention

The present invention relates to an image pickup apparatus such as a digital camera.

2. Description of Related Art

Recent years, a digital camera that can take a moving image has become commonplace among ordinary consumers. When using this type of digital camera to take a moving image of a noted subject, a photographer may adjust a zoom magnification, imaging direction and the like while confirming that the noted subject is within an imaging area with a monitor of the camera. In this case, a frame-out of the noted subject may occur due to a movement of the noted subject or other factors. In other words, the noted subject may be outside the imaging area. This type of frame-out occurs frequently in particular when the zoom magnification is set to a high magnification.

When the frame-out occurs, the photographer has missed the noted subject in many cases. In this case, the photographer usually cannot recognize how to adjust the imaging direction so that the noted subject is again brought into the imaging area. In this case, the photographer may temporarily change the zoom magnification to the low magnification side so that the noted subject can be easily brought into the imaging area. After the noted subject is actually brought into the imaging area, the zoom magnification is increased again to a desired magnification by the photographer.

Note that in a certain conventional method, a search space is set in an imaging field of view so as to detect a predetermined object from the search space. If it is decided that the object is at the upper edge or the left or right edge of the search space, a warning display is displayed to warn that the object is at any one the edges.

When the above-mentioned frame-out occurs, the noted subject should be brought into the imaging area as early as possible in accordance with the photographer's intention. Therefore, it is required to develop a technique to facilitate cancellation of the frame-out (a technique that enables the noted subject to be easily brought into the imaging area again). Note that the above-mentioned conventional method is a technique to warn risk of occurrence of the frame-out and cannot satisfy the above-mentioned requirement.

### SUMMARY OF THE INVENTION

An image pickup apparatus according to a first aspect of the present invention includes a first imaging portion that takes an image of subjects and outputs a signal corresponding to a result of the imaging, a second imaging portion that takes an image of the subjects with a wider angle than the first imaging portion and outputs a signal corresponding to a result of the imaging, and a report information output portion that outputs report information corresponding to a relationship between an imaging area of the first imaging portion and a position of the specific subject based on an output signal of the second imaging portion when a specific subject included in the subjects is outside an imaging area of the first imaging portion.

An image pickup apparatus according to a second aspect of the present invention includes a first imaging portion that takes an image of subjects and outputs a signal corresponding to a result of the imaging, a second imaging portion that takes an image of the subjects with a wider angle than the first imaging portion and outputs a signal corresponding to a result of the imaging, and a display portion that displays a relationship between an imaging area of the first imaging portion and an imaging area of the second imaging portion, together with a first image based on an output signal of the first imaging portion and a second image based on an output signal of the second imaging portion.

### BRIEF DESCRIPTION OF THE DRAWINGS

FIG. 1 is a schematic general block diagram of an image pickup apparatus according to a first embodiment of the present invention.

FIG. 2 is an internal block diagram of one imaging portion illustrated in FIG. 1.

FIG. 3A is a diagram in which an image pickup apparatus and periphery thereof are viewed from above in a situation where a specific subject is within two imaging areas of imaging portions.

FIG. 3B is a diagram in which the image pickup apparatus is viewed from the photographer's side in a situation where a specific subject is within two imaging areas of imaging portions.

FIGS. 4A and 4B are diagrams illustrating a narrow angle frame image and a wide angle frame image, respectively, obtained in the situation of FIG. 3A.

FIG. 5 is a diagram illustrating positional and dimensional relationships between the narrow angle frame image and the wide angle frame image.

FIG. 6 is a diagram illustrating a manner in which the specific subject is designated by touch panel operation.

FIGS. 7A, 7B and 7C are a diagram illustrating an example of display content of a display screen in a tracking mode, a diagram illustrating a manner in which a display area of the display screen is split in the tracking mode, and an enlarged diagram of wide angle image information displayed in the tracking mode, respectively.

FIG. 8A is a diagram in which the image pickup apparatus and periphery thereof are viewed from above in a situation where the specific subject is within only the imaging area of the wide angle imaging portion.

FIGS. 8B and 8C are diagrams illustrating a narrow angle frame image and a wide angle frame image, respectively, in the same situation as FIG. 8A.

FIG. 9 is a diagram illustrating an example of display content of a display screen when a frame-out occurs.

FIGS. 10A to 10C are diagrams illustrating examples (first to third examples) of display content of the display screen when a frame-out occurs.

FIG. 11 is a block diagram of a part included in the image pickup apparatus according to the first embodiment of the present invention.

FIG. 12 is a diagram illustrating an example of display content of a display screen according to a second embodiment of the present invention.

FIG. 13 is a diagram illustrating an example of display content of a display screen according to the second embodiment of the present invention.

FIG. 14 is a diagram illustrating an example of display content of a display screen according to the second embodiment of the present invention.

FIG. 15 is a diagram illustrating a manner in which a record target image is switched according to the second embodiment of the present invention.

### DETAILED DESCRIPTION OF THE PREFERRED EMBODIMENTS

Hereinafter, examples of embodiments of the present invention will be described with reference to the attached drawings. In the referred drawings, the same parts are denoted by the same numerals or symbols, and overlapping description of the same part is omitted as a rule.

### First Embodiment

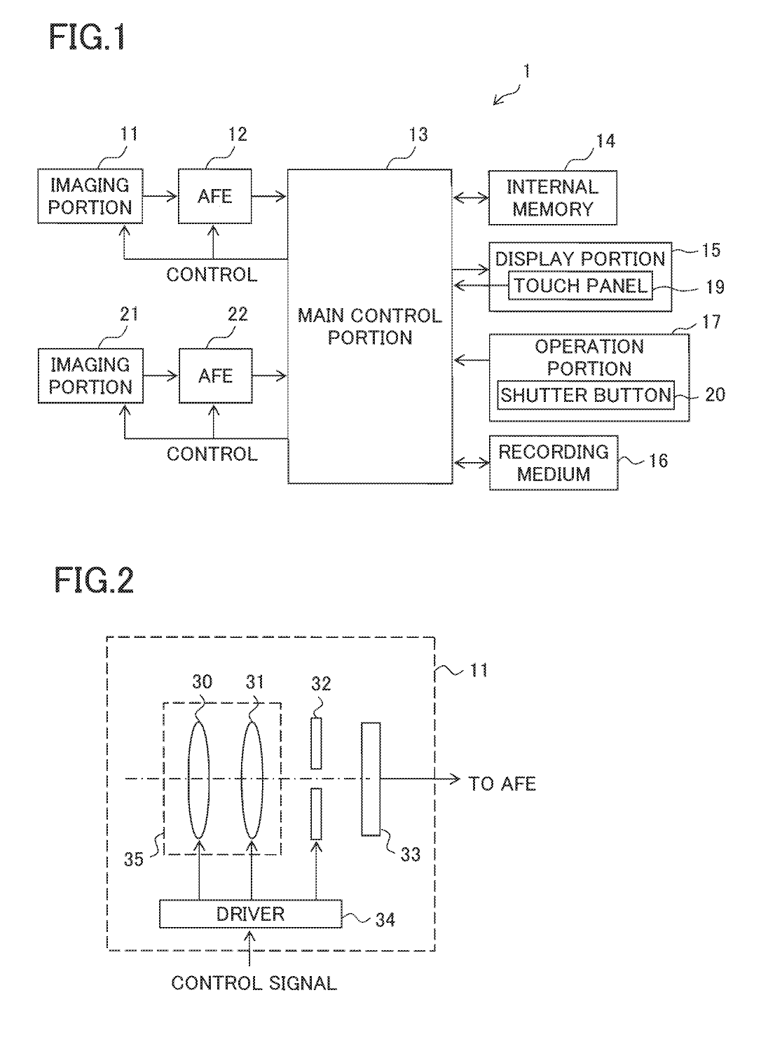

A first embodiment of the present invention is described. FIG. 1 is a schematic general block diagram of an image pickup apparatus 1 according to the first embodiment. The image pickup apparatus 1 is a digital still camera that can take and record still images or a digital video camera that can take and record still images and moving images. The image pickup apparatus 1 may be incorporated in a mobile terminal such as a mobile phone.

The image pickup apparatus 1 includes an imaging portion 11 as a first imaging portion, an analog front end (AFE) 12, a main control portion 13, a internal memory 14, a display portion 15, a recording medium 16, an operation portion 17, an imaging portion 21 as a second imaging portion, and an AFE 22.

FIG. 2 illustrates an internal block diagram of the imaging portion 11. The imaging portion 11 includes an optical system 35, an aperture stop 32, an image sensor 33 constituted of a charge coupled device (CCD) or a complementary metal oxide semiconductor (CMOS) image sensor, and a driver 34 for driving and controlling the optical system 35 and the aperture stop 32. The optical system 35 is constituted of a plurality of lenses including a zoom lens 30 and a focus lens 31. The zoom lens 30 and the focus lens 31 can move in the optical axis direction. The driver 34 drives and controls positions of the zoom lens 30 and the focus lens 31, and an opening degree of the aperture stop 32 based on control signals from the main control portion 13, so as to control focal length (angle of view) and focal position of the imaging portion 11 and incident light amount to the image sensor 33 (i.e., an aperture stop value).

The image sensor 33 performs photoelectric conversion of an optical image of a subject that enters via the optical system 35 and the aperture stop 32, and outputs an electric signal obtained by the photoelectric conversion to the AFE 12. More specifically, the image sensor 33 includes a plurality of light receiving pixels arranged in a matrix. In each imaging process, each of the light receiving pixels accumulates signal charge whose charge amount corresponds to exposure time. Analog signals from the light receiving pixels having amplitudes proportional to the charge amounts of the accumulated signal charges are sequentially output to the AFE 12 in accordance with a drive pulse generated in the image pickup apparatus 1.

The AFE 12 amplifies the analog signal output from the imaging portion 11 (the image sensor 33 in the imaging portion 11) and converts the amplified analog signal to a digital signal. The AFE 12 outputs this digital signal as first RAW data to the main control portion 13. An amplification degree of the signal amplification in the AFE 12 is controlled by the main control portion 13.

A structure of the imaging portion 21 is the same as the imaging portion 11, and the main control portion 13 can control the imaging portion 21 in the same manner as the imaging portion 11. However, the number of pixels of the image sensor 33 of the imaging portion 21 (the total number of pixels or the effective number of pixels) and the number of pixels of the image sensor 33 of the imaging portion 11 (the total number of pixels or the effective number of pixels) may be different to each other. Further, a position of the zoom lens 30 of the imaging portion 21 may be fixed, a position of the focus lens 31 of the imaging portion 21 may be fixed, and an opening degree of the aperture stop 32 of the imaging portion 21 may be fixed. In the case where the imaging portion 21 is used for assisting the imaging by the imaging portion 11 as this embodiment, the number of pixels of the image sensor 33 of the imaging portion 21 (the total number of pixels or the effective number of pixels) may be smaller than that of the imaging portion 11.

The AFE 22 amplifies the analog signal output from the imaging portion 21 (the image sensor 33 in the imaging portion 21) and converts the amplified analog signal to a digital signal. The AFE 22 outputs this digital signal as a second RAW data to the main control portion 13. The amplification degree of the signal amplification in the AFE 22 is controlled by the main control portion 13.

The main control portion 13 includes a central processing unit (CPU), a read only memory (ROM) and a random access memory (RAM). The main control portion 13 generates image data expressing a taken image of the imaging portion 11 based on the first RAW data from the AFE 12 and generates image data expressing a taken image of the imaging portion 21 based on the second RAW data from the AFE 22. Here, the generated image data contains a luminance signal and a color difference signal, for example. However, the first or the second RAW data is also one type of the image data, and the analog signal output from the imaging portion 11 or 21 is also one type of the image data. In addition, the main control portion 13 also has a function as a display control portion that controls display content of the display portion 15, and performs control necessary for display on the display portion 15.

The internal memory 14 is constituted of a synchronous dynamic random access memory (SDRAM) or the like, and temporarily stores various data generated in the image pickup apparatus 1. The display portion 15 is a display device having a display screen such as a liquid crystal display panel, and displays the taken image or the image stored in the recording medium 16 under control of the main control portion 13.

The display portion 15 is equipped with a touch panel 19, and a user as a photographer can give a specific instruction to the image pickup apparatus 1 by touching the display screen of the display portion 15 with a touching object. The operation of touching the display screen of the display portion 15 with the touching object is referred to as a touch panel operation. When the touching object touches the display screen of the display portion 15, a coordinate value indicating the touched position is transmitted to the main control portion 13. The touching object is a finger or a pen. Note that in this specification, being referred to simply as display or display screen means the display or the display screen of the display portion 15.

The recording medium 16 is a nonvolatile memory such as a card-like semiconductor memory or a magnetic disk, which stores the taken image or the like under control of the main control portion 13. The operation portion 17 includes a shutter button 20 for receiving an instruction to take a still image and the like, and receives other various external operations. An operation to the operation portion 17 is referred to as a button operation to be distinguished from the touch panel operation. Content of the operation to the operation portion 17 is transmitted to the main control portion 13.

Action modes of the image pickup apparatus 1 includes an imaging mode in which a still image or a moving image can be taken and a reproducing mode in which a still image or a moving image recorded in the recording medium 16 can be reproduced on the display portion 15. In the imaging mode, each of the imaging portions 11 and 21 periodically takes images of a subject at a predetermined frame period, so that the imaging portion 11 (more specifically the AFE 12) outputs first RAW data expressing a taken image sequence of the subject while the imaging portion 21 (more specifically the AFE 22) outputs second RAW data expressing a taken image sequence of the subject. An image sequence such as the taken image sequence means a set of images arranged in time series. The image data of one frame period expresses one image. The one taken image expressed by image data of one frame period from the AFE 12 or 22 is referred to also as a frame image. It can be interpreted that an image obtained by performing a predetermined image processing (a demosaicing process, a noise reduction process, a color correction process or the like) on the taken image of the first or the second RAW data is the frame image.

In the following description, a structure of the image pickup apparatus 1 related to the action in the imaging mode and the action of the image pickup apparatus 1 in the imaging mode are described unless otherwise noted.

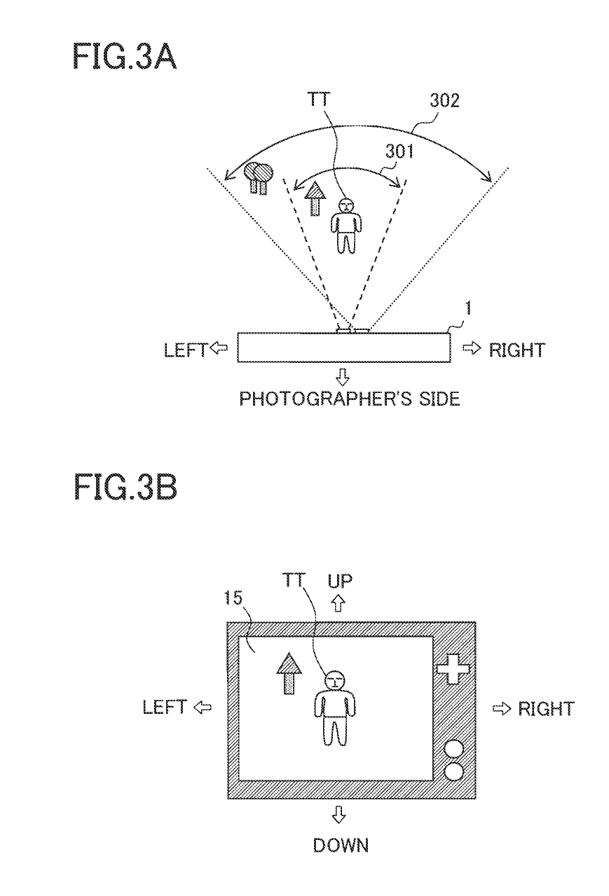

It is supposed that the photographer holds a body of the image pickup apparatus 1 with hands so as to take an image of subjects including a specific subject TT. FIG. 3A is a diagram in which the image pickup apparatus 1 and periphery thereof are viewed from above in this situation, and FIG. 3B is a diagram in which the image pickup apparatus 1 is viewed from the photographer's side in this situation. In FIG. 3B, the hatched area indicates a body part of the image pickup apparatus 1 enclosing the display screen of the display portion 15.

The display screen of the display portion 15 is disposed on the photographer's side of the image pickup apparatus 1, and the frame image sequence is displayed as the moving image based on the first or the second RAW data on the display screen. Therefore, the photographer can check a state of the subject within the imaging area of the imaging portion 11 or 21 by viewing display content on the display screen. The display screen and the subjects including the specific subject TT exist in front of the photographer. A right direction, a left direction, an upper direction and a lower direction in this specification respectively mean a right direction, a left direction, an upper direction and a lower direction viewed from the photographer.

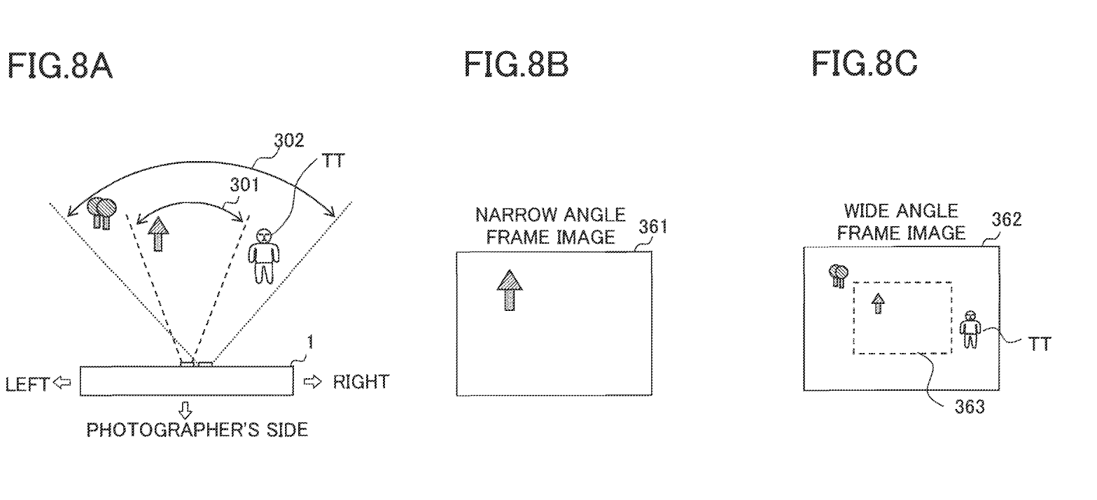

In this embodiment, the angle of view (field angle) of the imaging portion 21 is wider than the angle of view (field angle) of the imaging portion 11. In other words, the imaging portion 21 takes an image of a subject with wider angle than the imaging portion 11. In FIG. 3A, numeral 301 denotes the imaging area of the imaging portion 11 and the angle of view of the imaging portion 11, and numeral 302 denotes the imaging area of the imaging portion 21 and the angle of view of the imaging portion 21. Note that the center of the imaging area 301 and the center of the imaging area 302 are not identical in FIG. 3A for convenience sake of illustration, but it is supposed that the centers are identical (the same is true in FIG. 8A that will be referred to). The imaging area 301 is always included in the imaging area 302, and the entire imaging area 301 corresponds to a part of the imaging area 302. Therefore, the specific subject TT is always within the imaging area 302 if the specific subject TT is within the imaging area 301. On the other hand, even if the specific subject TT is not within the imaging area 301, the specific subject TT may be within the imaging area 302. In the following description, the imaging portion 11 and the imaging portion 21 may be referred to as a narrow angle imaging portion 11 and a wide angle imaging portion 21, respectively, and the imaging areas 301 and 302 may be referred to as a narrow angle imaging area 301 and a wide angle imaging area 302, respectively.

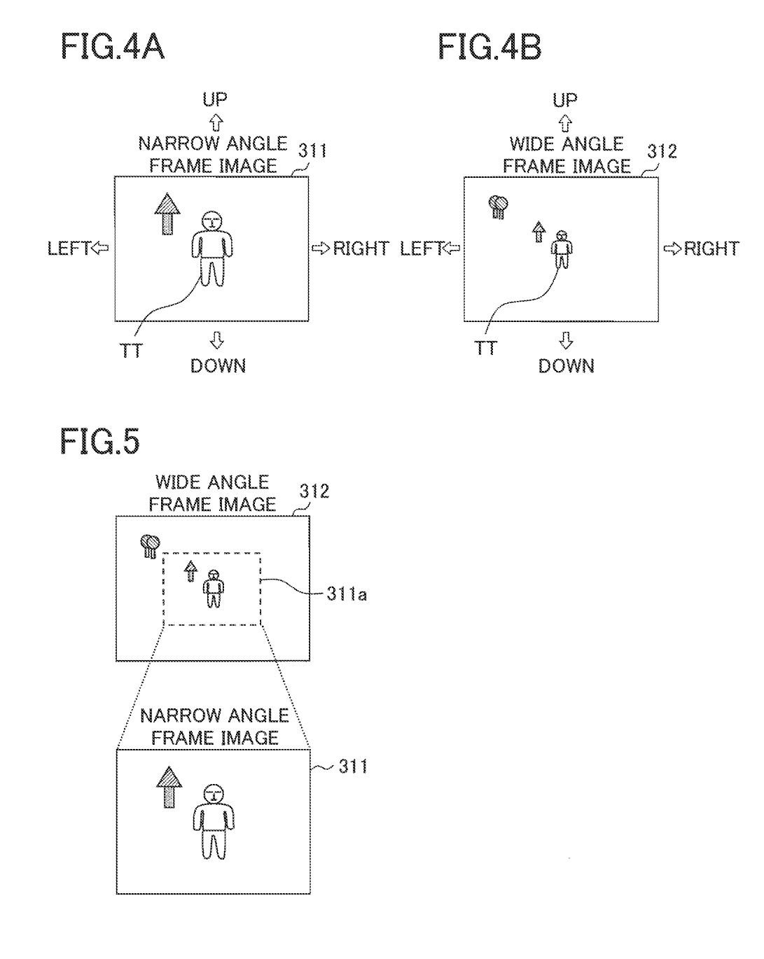

The frame image based on the output signal of the narrow angle imaging portion 11 is particularly referred to as a narrow angle frame image, and the frame image based on the output signal of the wide angle imaging portion 21 is particularly referred to as a wide angle frame image. The images 311 and 312 in FIGS. 4A and 4B are respectively a narrow angle frame image and a wide angle frame image obtained at the same imaging timing. At the same imaging timing, the specific subject TT is positioned at the center of the narrow angle imaging area 301. As a result, the specific subject TT appears at the center of the narrow angle frame image 311. Similarly, at the same imaging timing, the specific subject TT is positioned at the center of the wide angle imaging area 302. As a result, the specific subject TT appears at the center of the wide angle frame image 312. Supposing that optical axes of the imaging portions 11 and 21 are parallel to each other and that all the subjects are positioned on the plane orthogonal to the optical axes of the imaging portions 11 and 21, the subjects positioned on the right, left, upper and lower sides of the specific subject TT in the real space respectively appear on the right, left, upper and lower sides of the specific subject TT on the narrow angle frame image 311, and respectively appear on the right, left, upper and lower sides of the wide angle frame image 312, too.

The image pickup apparatus 1 recognizes a positional relationship and a dimensional relationship between the narrow angle imaging area 301 and the wide angle imaging area 302, and recognizes a correspondent relationship between each position on the wide angle frame image and each position on the narrow angle frame image. FIG. 5 illustrates a relationship between the wide angle frame image and the narrow angle frame image. In FIG. 5, a broken line box denoted by numeral 311a indicates a contour of the narrow angle frame image disposed on the wide angle frame image. The image pickup apparatus 1 can recognize positions on the wide angle frame image of the subjects on the positions of the narrow angle frame image based on the above-mentioned correspondent relationship. On the contrary, based on the above-mentioned correspondent relationship, the image pickup apparatus 1 can recognize positions on the narrow angle frame image of the subjects on the positions of the wide angle frame image (positions in the contour 311a).

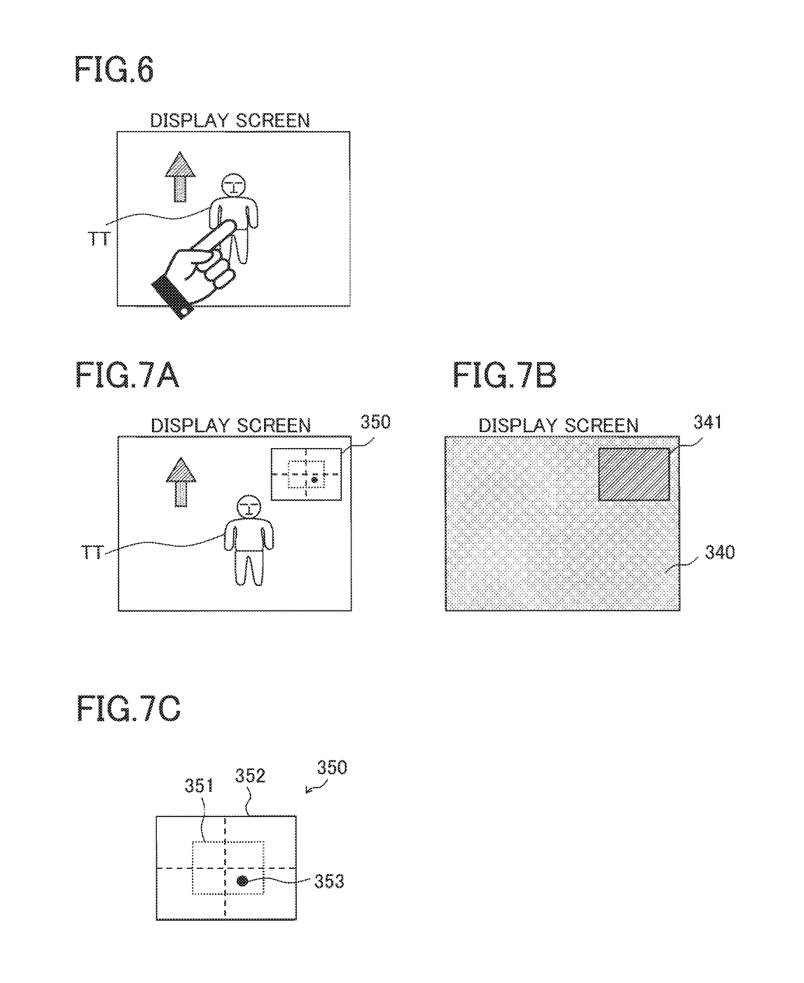

An action in the tracking mode as one of the imaging modes is described. In the tracking mode, the narrow angle frame image sequence is displayed as a moving image on the display screen. The photographer adjusts the imaging direction and the like of the image pickup apparatus 1 so that the specific subject TT is within the narrow angle imaging area 301, and designates the specific subject TT by the touch panel operation as illustrated in FIG. 6. Thus, the specific subject TT is set as a tracking target. Note that it is possible to designate the tracking target by the button operation. Alternatively, the image pickup apparatus 1 may automatically set the tracking target using a face recognition process or the like.

In the tracking mode, the narrow angle frame image sequence can be recorded as a moving image in the recording medium 16. However, it is possible to record the wide angle frame image sequence as a moving image in the recording medium 16 in the tracking mode. It is also possible to record the narrow angle frame image sequence and the wide angle frame image sequence as two moving images in the recording medium 16 in the tracking mode.

When the specific subject TT is set as the tracking target, the main control portion 13 performs a tracking process. In the main control portion 13, a first tracking process based on image data of the narrow angle frame image sequence and a second tracking process based on image data of the wide angle frame image sequence are performed.

In the first tracking process, positions of the tracking target on the individual narrow angle frame images are sequentially detected based on the image data of the narrow angle frame image sequence. In the second tracking process, positions of the tracking target on the individual wide angle frame images are sequentially detected based on the image data of the wide angle frame image sequence. The first and the second tracking processes can be performed based on image feature character of the tracking target. The image feature contains luminance information and color information.

The first tracking process between the first and the second images to be operated can be performed as follows. The first image to be operated means the narrow angle frame image in which position of the tracking target has been detected, and the second image to be operated means the narrow angle frame image in which the position of the tracking target is to be detected. The second image to be operated is an image that is usually taken next to the first image to be operated. A tracking box that is estimated to have the same size as a tracking target area is set in the second image to be operated, and similarity estimation between the image feature of image in the tracking box in the second image to be operated and the image feature of image in the tracking target area in the first image to be operated is performed while position of the tracking box is changed sequentially in the tracking area. Then, it is decided that the center position of the tracking target area in the second image to be operated is located at the center position of the tracking box having a maximum similarity. The tracking area for the second image to be operated is set with reference to the position of the tracking target in the first image to be operated. The tracking target area means an image area in which image data of the tracking target exists. The center position of the tracking target area can be regarded as the position of the tracking target.

After the center position of the tracking target area in the second image to be operated is decided, a known contour extraction process or the like is used as necessary so that a closed area including the center position and enclosed by edges can be extracted as the tracking target area in the second image to be operated. Alternatively, it is possible to extract an approximate area of the closed area with a simple figure (a rectangle or an ellipse) as the tracking target area.

The second tracking process is also realized by the same method as the first tracking process. However, in the second tracking process, the first image to be operated means the wide angle frame image in which position of the tracking target has been detected, and the second image to be operated means the wide angle frame image in which position of the tracking target is to be detected.

Other than that, any known tracking method (e.g., a method described in JP-A-2004-94680 or a method described in JP-A-2009-38777) may be used to perform the first and the second tracking process.

FIG. 7A illustrates display content of a display screen in the tracking mode. A main display area 340 corresponding to the dot area of FIG. 7B and a sub display area 341 corresponding to the hatched area of FIG. 7B are disposed on the entire display area of the display screen. In the tracking mode, the narrow angle frame image sequence is displayed as a moving image in the main display area 340 while wide angle image information 350 is displayed in the sub display area 341. A positional relationship between the main display area 340 and the sub display area 341 is arbitrary, and position and size of the sub display area 341 on the display screen are arbitrary. However, it is desirable that size (area) of the main display area 340 is larger than that of the sub display area 341. It is possible to change position and size of the sub display area 341 in accordance with position and size of the tracking target in the narrow angle frame image sequence, so that the display of the tracking target in the narrow angle frame image sequence is not disturbed. Note that when an arbitrary two-dimensional image such as the narrow angle frame image or the wide angle frame image is displayed on the display screen, resolution of the two-dimensional image is changed as necessary so as to be adapted to the number of pixels of the display screen, but in this specification, for simple description, the change of resolution of the display is omitted.

FIG. 7C illustrates an enlarged diagram of the wide angle image information 350. The wide angle image information 350 includes an icon 351 of a rectangular box indicating a contour of the narrow angle imaging area 301, an icon 352 of a rectangular box indicating a contour of the wide angle imaging area 302, and a dot-like icon 353 indicating position of the tracking target on the wide angle imaging area 302 and the narrow angle imaging area 301. The icons 351 to 353 are displayed in the sub display area 341. In the example illustrated in FIG. 7C, the wide angle image information 350 is provided with two broken lines each of which equally divides the rectangular box of the icon 352 into two in the vertical or the horizontal direction.

The icon 351 is disposed in the icon 352 so that the positional and dimensional relationships between the range in the rectangular box of the icon 351 and the range in the rectangular box of the icon 352 agree or substantially agree with the positional and dimensional relationships between the narrow angle imaging area 301 and the wide angle imaging area 302 in the real space. In other words, the positional and dimensional relationships between the rectangular box of the icon 351 and the rectangular box of the icon 352 is the same or substantially the same as the positional and dimensional relationships between the contour 311a of the narrow angle frame image and the contour of the wide angle frame image 312 illustrated in FIG. 5.

The display position of the icon 353 is determined in accordance with position of the tracking target on the narrow angle frame image sequence based on a result of the first tracking process or position of the tracking target on the wide angle frame image sequence based on a result of the second tracking process. In other words, regarding the rectangular box of the icon 351 as the contour of the narrow angle frame image, the icon 353 is displayed at the position on the icon 351 corresponding to the position of the tracking target on the narrow angle frame image sequence (however, if a narrow angle frame-out that will be described later occurs, the icon 353 is displayed outside the icon 351). Similarly, regarding the rectangular box of the icon 352 as the contour of the wide angle frame image, the icon 353 is displayed at the position on the icon 352 corresponding to the position of the tracking target on the wide angle frame image sequence.

The photographer can recognize the position of the tracking target in the wide angle imaging area 302 by viewing the wide angle image information 350.

In some case such as a case where the zoom magnification in the narrow angle imaging portion 11 is set to a high magnification, a small change of the imaging direction or a small movement of the subject may bring the tracking target outside the narrow angle imaging area 301. The situation where the tracking target is outside the narrow angle imaging area 301, namely, the situation where the tracking target is outside the narrow angle imaging area 301 is referred to as “narrow angle frame-out”.

Here, a situation a is supposed, in which the specific subject TT is set as the tracking target, and then the tracking target moves to the right in the real space so that the narrow angle frame-out occurs. However, it is supposed that the tracking target is within the wide angle imaging area 302 in the situation a. FIG. 8A is a diagram in which the image pickup apparatus 1 and periphery thereof are viewed from above in the situation a. FIGS. 8B and 8C illustrate a narrow angle frame image 361 and a wide angle frame image 362, respectively, which are taken in the situation a. In FIG. 8C, a broken line rectangular box 363 indicates a contour of the narrow angle frame image 361 disposed on the wide angle frame image 362.

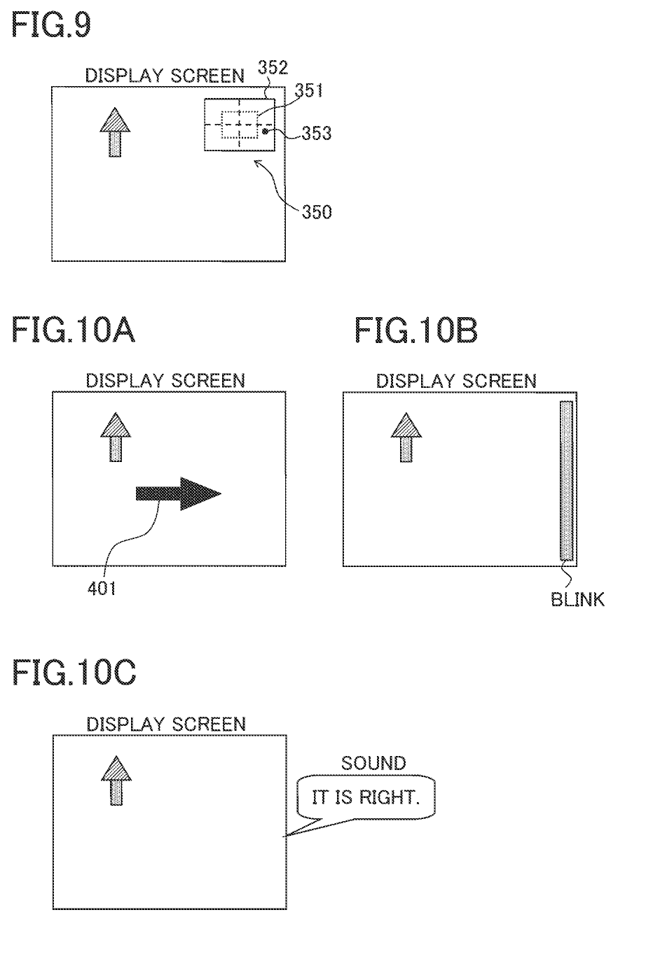

A display screen in the situation a is illustrated in FIG. 9. As described above, the narrow angle frame image sequence is displayed as a moving image on the display screen, but there is no tracking target in the narrow angle frame image sequence on the display screen because the narrow angle frame-out has occurred. On the other hand, the above-mentioned wide angle image information 350 is continuously displayed. When the narrow angle frame-out is generated, similarly to the case where no narrow angle frame-out is generated, the rectangular box of the icon 352 is regarded as the contour of the wide angle frame image, and the icon 353 is displayed at the position of the icon 352 corresponding to the position of the tracking target on the wide angle frame image sequence. Therefore, when the narrow angle frame-out is occurred, the display position of the icon 353 is determined in accordance with the position of the tracking target on the wide angle frame image sequence based on a result of the second tracking process.

As apparent from the above-mentioned description, the icons 351 and 352 indicate the narrow angle imaging area 301 and the wide angle imaging area 302, respectively, and the icon 353 indicates the position of the tracking target. Therefore, the wide angle image information 350 consisting of the icons 351 to 353 works as information (report information) indicating a relationship among the narrow angle imaging area 301, the wide angle imaging area 302 and the position of the tracking target. Accordingly, the photographer can easily bring the tracking target again into the narrow angle imaging area 301 thanks to the wide angle image information 350 in the situation a. In other words, by viewing the wide angle image information 350 as illustrated in FIG. 9, it is easy to confirm that the tracking target is positioned on the right side of the image pickup apparatus 1. Therefore, by moving the imaging direction of the image pickup apparatus 1 to the right side in accordance with the recognized content, the tracking target can be within the narrow angle imaging area 301 again.

Note that the wide angle image information 350 is displayed also in the situation where the narrow angle frame-out is not occurred in the above-mentioned specific example, but it is possible to display the wide angle image information 350 only in the situation where the narrow angle frame-out is occurred.

In addition, it is also possible to display the wide angle frame image sequence instead of the icon 352. In other words, the moving image of the wide angle frame image sequence may be displayed at the position where the icon 352 is to be displayed, and the icons 351 and 353 may be displayed to be superposed on the wide angle frame image sequence in the sub display area 341. In this case, in the situation where the narrow angle frame-out is not occurred, the narrow angle frame image sequence may be displayed in the main display area 340, and the wide angle frame image sequence may be displayed in the sub display area 341. Then, when occurrence of the narrow angle frame-out is detected, the image sequence to be displayed in the main display area 340 may be changed from the narrow angle frame image sequence to the wide angle frame image sequence, while the image sequence to be displayed in the sub display area 341 may be changed from the wide angle frame image sequence to the narrow angle frame image sequence.

The main control portion 13 can check whether or not the narrow angle frame-out has occurred based on a result of the first tracking process (namely, can check whether or not the narrow angle frame-out is occurred). For instance, if the position of the tracking target on the narrow angle frame image cannot be detected by the first tracking process, it can be decided that the narrow angle frame-out has occurred. In this case, it is possible to consider also the position of the tracking target on the narrow angle frame image that has been detected in the past by the first tracking process so as to check whether or not the narrow angle frame-out has occurred. The main control portion 13 can also detect whether or not the narrow angle frame-out has occurred based on a result of the second tracking process. It is easy to check whether or not the narrow angle frame-out has occurred from the position of the tracking target on the wide angle frame image based on a result of the second tracking process and the above-mentioned correspondent relationship that is recognized in advance (the correspondent relationship between each position on the wide angle frame image and each position on the narrow angle frame image). As a matter of course, the main control portion 13 can check whether or not the narrow angle frame-out has occurred based on both a result of the first tracking process and a result of the second tracking process.

According to this embodiment, when the narrow angle frame-out has occurred, the photographer can refer to the wide angle image information 350 based on an output of the wide angle imaging portion 21. By checking the wide angle image information 350, the tracking target can be easily brought into the narrow angle imaging area 301 without necessity of temporarily decreasing the zoom magnification of the narrow angle imaging portion 11.

Note that the method of using the imaging portions 11 and 21 as the narrow angle imaging portion and the wide angle imaging portion in the tracking mode is described above, and it is preferable to provide the stereo camera mode in which the imaging portions 11 and 21 are used as a stereo camera as one of the imaging modes. In the stereo camera mode, angles of view of the imaging portions 11 and 21 are the same as each other.

[First Report Information]

The above-mentioned wide angle image information 350 is an example of report information that is presented to the photographer when the narrow angle frame-out occurs. The wide angle image information 350 is referred to as first report information. When the narrow angle frame-out occurs, other report information than the first report information may be presented to the photographer. Second to fourth report information are described below as examples of the other report information that can be presented when the narrow angle frame-out occurs.

[Second Report Information]

The second report information is described. The second report information is image information for providing the photographer with the direction where the tracking target exists (hereinafter referred to as tracking target presence direction), when the narrow angle frame-out occurs. In other words, the second report information is image information for providing the photographer with the direction where the tracking target exists viewed from the image pickup apparatus 1. The tracking target presence direction indicates the tracking target presence direction viewed from the image pickup apparatus 1 and also indicates the direction to move the image pickup apparatus 1 for bringing the tracking target again into the narrow angle imaging area 301. For instance, as illustrated in FIG. 10A, an arrow icon 401 indicating the tracking target presence direction in the situation a is displayed as the second report information. Instead of the arrow icon 401, words indicating the tracking target presence direction (e.g., words “Tracking target is in the right direction”) may be displayed as the second report information. Alternatively, the words may be displayed together with the arrow icon 401.

In addition, it is possible to derive a movement amount of the image pickup apparatus 1 necessary for bringing the tracking target again into the narrow angle imaging area 301 based on the position of the tracking target on the wide angle frame image sequence based on a result of the second tracking process and the positional and dimensional relationships between the wide angle frame image and the narrow angle frame image, so that the second report information contains the information corresponding to the movement amount. Alternatively, information corresponding to the movement amount may be reported to the photographer separately from the second report information. For instance, the length of the arrow icon 401 may be changed in accordance with the derived movement amount. Thus, the photographer can recognize how much the image pickup apparatus 1 should be moved to bring the tracking target again into the narrow angle imaging area 301. Note that the movement amount may be a parallel movement amount of image pickup apparatus 1. When the image pickup apparatus 1 is panned or tilted, the movement amount may be a rotation amount of the image pickup apparatus 1.

[Third Report Information]

The form of the image information for presenting the tracking target presence direction to the photographer when the narrow angle frame-out occurs can be changed variously, and the third report information contains any image information for providing the photographer with the tracking target presence direction. For instance, as illustrated in FIG. 10B, in the situation a, an end portion of the display screen corresponding to the tracking target presence direction may blink, or the end portion may be colored with a predetermined warning color.

[Fourth Report Information]

The information for presenting the tracking target presence direction to the photographer when the narrow angle frame-out occurs may be any information that can be perceived by one of five human senses, and the fourth report information contains any information for presenting the tracking target presence direction to the photographer by affecting one of five human senses. For instance, as illustrated in FIG. 10C, in the situation a, the tracking target presence direction may be reported to the photographer by sound.

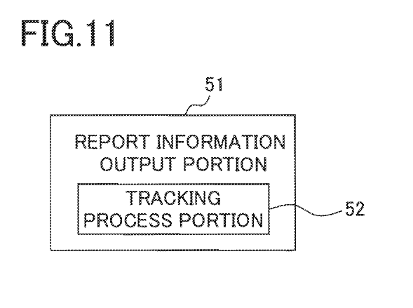

Note that it is possible to consider that the image pickup apparatus 1 is provided with a report information output portion 51 that generates and outputs any report information described above (see FIG. 11). The report information output portion 51 can be considered to be included in the main control portion 13 illustrated in FIG. 1. However, if the report information is presented to the photographer using an image display, it is possible to consider that the display portion 15 is also included in the report information output portion 51 as a component. Similarly, if the report information is presented to the photographer using a sound output, it is possible to consider that a speaker (not shown) in the image pickup apparatus 1 is also included in the report information output portion 51 as a component. The report information output portion 51 includes a tracking process portion 52 that performs the above-mentioned first and second tracking processes. The report information output portion 51 detects whether or not the narrow angle frame-out has occurred based on a result of the first or the second tracking process by the tracking process portion 52 or based on results of the first and the second tracking processes by the tracking process portion 52. The report information output portion 51 also generates and outputs the report information using a result of the second tracking process when the narrow angle frame-out occurs.

### Second Embodiment

The second embodiment of the present invention is described. The second embodiment is an embodiment on the basis of the first embodiment, and the description of the first embodiment can be also applied to the second embodiment unless otherwise noted in the second embodiment.

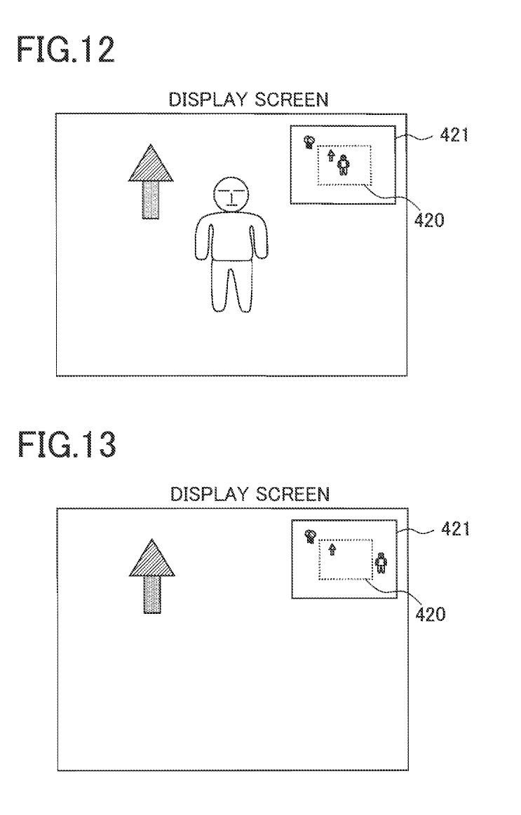

An action of a special imaging mode as one type of the imaging mode is described. In the special imaging mode, as illustrated in FIG. 12, the narrow angle frame image sequence is displayed as a moving image in the main display area 340, and at the same time the wide angle frame image sequence is displayed as a moving image in the sub display area 341 (see also FIG. 7B). The display of the narrow angle frame image sequence in the main display area 340 and the wide angle frame image sequence in the sub display area 341 simultaneously is referred to as narrow angle main display for convenience sake. A rectangular box 420 is displayed to be superposed on the wide angle frame image displayed in the sub display area 341. The rectangular box 420 has the same meaning as the icon 351 of the rectangular box illustrated in FIG. 7C. Therefore, the rectangular box 420 indicates a contour of the narrow angle imaging area 301 on the wide angle frame image. On the other hand, a solid line rectangular box 421 (see FIG. 12) displayed on the display screen indicates a contour of the wide angle frame image, namely a contour of the wide angle imaging area 302. Note that any side of the rectangular box 421 may overlap the contour of the display screen.

In this way, in the special imaging mode, the narrow angle frame image sequence and the wide angle frame image sequence are displayed. At the same time, a positional relationship between the narrow angle imaging area 301 and the wide angle imaging area 302 as well as a dimensional relationship between the narrow angle imaging area 301 and the wide angle imaging area 302 are also displayed by the rectangular boxes 420 and 421.

In the special imaging mode, the photographer can instruct to record the narrow angle frame image sequence by a predetermined button operation or touch panel operation. When this instruction is issued, the image pickup apparatus 1 records the image data of the narrow angle frame image sequence in the recording medium 16 while the display as illustrated in FIG. 12 is performed.

The photographer can check situation surrounding the narrow angle imaging area 301 to be a record target on the display screen by viewing the wide angle frame image sequence displayed on the sub display area 341, and can change the imaging direction of the image pickup apparatus 1 and the angle of view of the narrow angle imaging portion 11 as necessary. In other words, it is possible to assist adjustment of imaging composition or the like.

In addition, as illustrated in FIG. 13, when the specific subject (person in FIG. 13) to be noted is brought outside the narrow angle imaging area 301, the display of the specific subject is removed from the main display area 340. However, by viewing the sub display area 341, the photographer can easily recognize the position of the specific subject with respect to the relationship to the narrow angle imaging area 301 (corresponding to the rectangular box 420). By performing the adjustment of the imaging direction or the like in accordance with the recognized content, it is easy to bring the specific subject into the narrow angle imaging area 301 again.

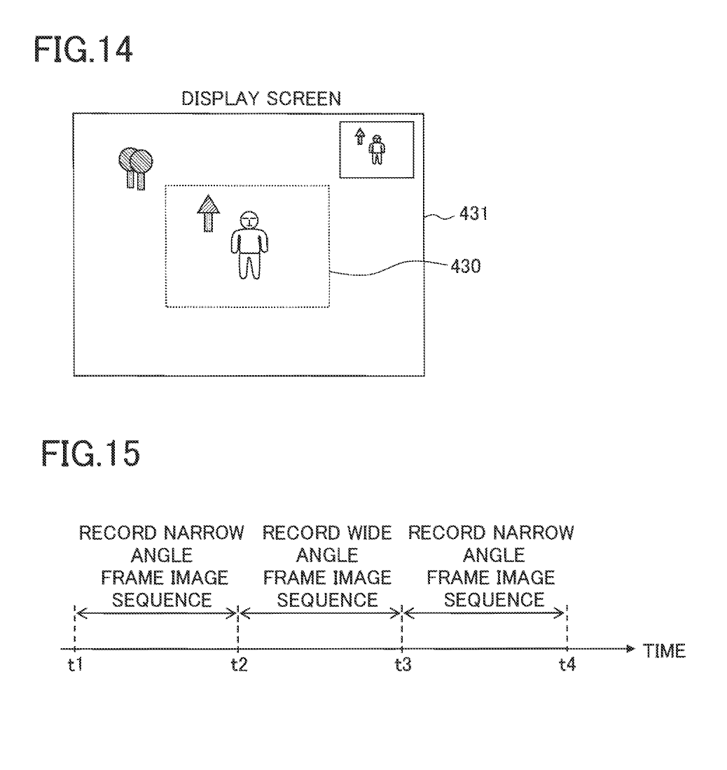

On the contrary, in the special imaging mode, as illustrated in FIG. 14, it is possible to display the wide angle frame image sequence as a moving image in the main display area 340 and to display the narrow angle frame image sequence as a moving image in the sub display area 341 simultaneously (see also FIG. 7B). The display of the wide angle frame image sequence in the main display area 340 and the narrow angle frame image sequence in the sub display area 341 simultaneously is referred to as a wide angle main display for convenience sake. In the wide angle main display, a rectangular box 430 is displayed to be superposed on the wide angle frame image displayed in the main display area 340. The rectangular box 430 has the same meaning as the rectangular box 420 illustrated in FIG. 12. Therefore, the rectangular box 430 indicates a contour of the narrow angle imaging area 301 on the wide angle frame image. On the other hand, in FIG. 14, a contour of the display screen corresponds to a contour 431 of the wide angle frame image. Therefore, in the wide angle main display too, the narrow angle frame image sequence and the wide angle frame image sequence are displayed, and at the same time the positional relationship between the narrow angle imaging area 301 and the wide angle imaging area 302 as well as the dimensional relationship between the narrow angle imaging area 301 and the wide angle imaging area 302 are also displayed.

While the wide angle main display is performed, the photographer can also instructs to record the narrow angle frame image sequence by a predetermined button operation or touch panel operation. When this instruction is issued, the image pickup apparatus 1 records the image data of the narrow angle frame image sequence in the recording medium 16 while the display as illustrated in FIG. 14 is performed.

In addition, in the special imaging mode, the photographer can instruct to switch the record target image by issuing a switch instruction operation to the image pickup apparatus 1. The switch instruction operation is realized by a predetermined button operation or touch panel operation. When this instruction is issued, a record control portion (not shown) included in the main control portion 13 switches the record target image between the narrow angle frame image and the wide angle frame image.

For instance, as illustrated in FIG. 15, it is supposed that an operation to instruct start of recording image data of the narrow angle frame image sequence is performed at time point t1, the switch instruction operation is performed at time point t2 after the time point t1, the switch instruction operation is performed again at time point t3 after the time point t2, and an instruction to finish recording of the image data is issued at time point t4 after the time point t3. In this case, the record control portion records the narrow angle frame image sequence as the record target image in the recording medium 16 during a period between the time points t1 and t2, records the wide angle frame image sequence as a record target image in the recording medium 16 during a period between the time points t2 and t3, and records the narrow angle frame image sequence as the record target image in the recording medium 16 during a period between the time points t3 and t4. As a result, at time point t4, the narrow angle frame image sequence between the time points t1 and t2, the wide angle frame image sequence between the time points t2 and t3, and the narrow angle frame image sequence between the time points t3 and t4 are stored in the recording medium 16.

Usually, in order to change the angle of view in imaging, it is necessary to secure a period of time corresponding to a change amount of the angle of view. For instance, in order to increase the zoom magnification from one to five so as to enlarge the noted subject, it is necessary to secure a suitable period of time (e.g., one second) for moving the zoom lens. On the other hand, by using the switch instruction operation as described above, it is possible to instantly change the angle of view of an image recorded in the recording medium 16 between the wide angle and the narrow angle. Thus, it is possible to avoid missing of an important scene to be imaged and to create an active moving image.

Note that it is possible to change a display method in accordance with a record target image so that the narrow angle main display corresponding to FIG. 12 is performed during a period while the narrow angle frame image sequence is being recorded in the recording medium 16, and that the wide angle main display corresponding to FIG. 14 is performed during a period while the wide angle frame image sequence is being recorded in the recording medium 16.

In addition, instead of switching the record target image in accordance with the switch instruction operation, it is possible to switch the record target image in accordance with whether or not the narrow angle frame-out has occurred. In other words, the record target image may be switched in accordance with whether or not the tracking target is within the narrow angle imaging area 301. Specifically, for example, as described above in the first embodiment, the main control portion 13 detects (i.e., decides) whether or not the narrow angle frame-out has occurred. Then, for example, the record control portion may record the narrow angle frame image sequence as a record target image in the recording medium 16 in a period during which the narrow angle frame-out is decided not to be occurred, and may record the wide angle frame image sequence as a record target image in the recording medium 16 in a period during which the narrow angle frame-out is decided to be occurred. When the narrow angle frame-out occurs, it is considered to be better for following the photographer's intention to record not the narrow angle frame image in which the tracking target does not exist but the wide angle frame image in which the tracking target exists with high probability.

In addition, it is also possible to change the display position of the narrow angle frame image and the display position of the wide angle frame image on the display portion 15 in accordance with whether or not the tracking target is within the narrow angle imaging area 301 (Note that this method of change overlaps one of the methods described above in the first embodiment). Specifically, for example, as described above in the first embodiment, the main control portion 13 detects (i.e., decides) whether or not the narrow angle frame-out has occurred. Then, for example, the narrow angle main display may be performed in a period during which the narrow angle frame-out is decided not to be occurred, and the wide angle main display may be performed in a period during which the narrow angle frame-out is decided to be occurred. When the narrow angle frame-out occurs, the tracking target does not exist on the narrow angle frame image. Therefore, it can be said that it is better, for adjustment of composition or the like, to display not the narrow angle frame image in the main display area 340 but the wide angle frame image in the main display area 340.

<<Variations>>

The embodiments of the present invention can be modified variously as necessary within the scope of the technical concept described in claims. The embodiments described above are merely examples of the embodiments of the present invention, and meanings of the present invention and terms of elements thereof should not be limited to those described in the embodiments. The specific values described in the description are merely examples, which can be changed variously as a matter of course. As annotations that can be applied to the embodiments, Note 1 and Note 2 are described below. The contents of the notes can be combined arbitrarily as long as no contradiction arises.

[Note 1]

The two imaging portions are disposed in the image pickup apparatus 1 illustrated in FIG. 1, but it is possible to dispose three or more imaging portions in the image pickup apparatus 1, and to apply the present invention to the three or more imaging portions.

[Note 2]

The image pickup apparatus 1 illustrated in FIG. 1 can be constituted of hardware or a combination of hardware and software. When the image pickup apparatus 1 is constituted using software, the block diagram of each part realized by the software expresses a functional block diagram of the part. The function realized using the software may be described as a program, and the program may be executed by a program executing device (e.g., a computer) so that the function is realized.

What is claimed is:

1. An image pickup apparatus comprising:
a first imaging portion that takes an image of subjects and outputs a signal corresponding to a result of the imaging;
a second imaging portion that takes an image of the subjects with a wider angle than the first imaging portion and outputs a signal corresponding to a result of the imaging; and
a report information output portion that outputs report information corresponding to a relationship between an imaging area of the first imaging portion and a position of a specific subject based on an output signal of the second imaging portion when the specific subject included in the subjects is outside the imaging area of the first imaging portion.

2. The image pickup apparatus according to claim 1, wherein the report information output portion includes a tracking process portion that tracks the specific subject based on the output signal of the second imaging portion, and generates the report information based on a result of tracking the specific subject when the specific subject is outside the imaging area of the first imaging portion.

3. An image pickup apparatus comprising:
a first imaging portion that takes an image of subjects and outputs a signal corresponding to a result of the imaging;
a second imaging portion that takes an image of the subjects with a wider angle than the first imaging portion and outputs a signal corresponding to a result of the imaging; and
a display portion that displays a relationship between an imaging area of the first imaging portion and an imaging area of the second imaging portion, together with a first image based on an output signal of the first imaging portion and a second image based on an output signal of the second imaging portion.

4. The image pickup apparatus according to claim 3, further comprising a record control portion that controls a recording medium to record one of the first image and the second image as a record target image, wherein
the record control portion switches the record target image between the first and the second images in accordance with an input switch instruction operation.

5. The image pickup apparatus according to claim 3, further comprising a record control portion that controls a recording medium to record one of the first image and the second image as a record target image, wherein
the record control portion switches the record target image between the first and the second images in accordance with whether or not a specific subject included in the subjects is within the imaging area of the first imaging portion.

6. The image pickup apparatus according to claim 3, wherein display position of the first image and display position of the second image on the display portion are changed in accordance with whether or not a specific subject included in the subjects is within the imaging area of the first imaging portion.
